(19) United States
(12) Patent Application Publication
(10) Pub. No.: US 2018/0091330 A1
(43) Pub. Date: Mar. 29, 2018

(54) COMMUNICATION NETWORK

(71) Applicant: Abdelmajid El Abbouti, Bellegarde sur Valserine (FR)

(72) Inventor: Abdelmajid El Abbouti, Bellegarde sur Valserine (FR)

(21) Appl. No.: 15/566,339

(22) PCT Filed: Apr. 12, 2016
(86) PCT No.: PCT/IB2016/052067

§ 371 Date: Oct. 13, 2017

(30) Foreign Application Priority Data
Apr. 14, 2015 (FR) 15 53273

(51) Int. Cl. H04L 12/413; H04L 12/28; H04L 12/433; H04L 12/40

(52) U.S. Cl. CPC H04L 12/413; H04L 12/2838; G05B 15/02; H04L 12/40006; H04L 12/433

(57) ABSTRACT

A communication device in a home network, for communication, by means of messages sent on the network (1) in the form of frames including a plurality of functional segments, between actors (4-18) of the network that each have an electronic interface (4a-18a) having a communication program and are associated with devices (4b-18b) in a building (2). The message frame includes a message start binary signal, an address segment, a data length indication segment, a data segment, a control segment containing a key calculated on the basis of the signals making up the message, and a message end binary signal. The communication program for each actor (4-18) includes an initial wait sequence, on the basis of which the actor must search for the possible presence of messages on the network (1) before sending a message and, after having noted the absence of messages on the network (1), must wait for a rest period, the duration of which has been assigned solely to said actor, and only send its message on the network (1) if no other message has appeared during the rest period.

### TECHNICAL FIELD OF THE INVENTION

The present invention relates to the home automation systems intended to drive members in a residence building as a whole.

The invention relates more particularly to the home automation systems in which equipment items can exchange information on their status and their operation with one another or with a centralized or decentralized control system.

In the motor vehicle industry, to reduce the number of electric conductors having to link the active elements to one another and to the control system, a local area network has been developed based on a bus made up of a pair of twisted or coaxial conductors or on an optical fiber, to which are connected active elements comprising an electronic interface with a microcontroller. For example, such a local area network can be constructed on the basis of the Intel series 82526 communication controller, in which the exchanges of information between the active elements proceed according to a standardized protocol called CAN (“Controller Area Network”).

Such a local area network is well suited to the motor vehicle industry, to be embedded on the motor vehicles.

However, such a network is not particularly well suited to controlling home automation systems, in as much as the active members of the home automation systems have particular features and needs which differ from those which characterize the motor vehicles.

In particular, the fixed format of the messages exchanged according to the CAN protocol, although satisfactory for use in a motor vehicle, is too limited by the number of connectable objects allowed, by the transmissible information whose volume is too small for the communications which are necessary between active members of the home automation systems, and it does not make it possible to manage alarm priorities.

The document EP 0 005 045 A discloses a system for communication between several equipment items on a network, the equipment items each having an electronic interface, the communications being established by means of messages transmitted over the network in the form of frames comprising a plurality of functional segments. The frame of the messages comprises a start-of-message segment, an address segment, a data segment, a control segment containing a key computed as a function of the signals that make up the message, and an end-of-message binary signal. During communications, the network assumes either a dominant state or a recessive state.

In the device described in this document, when two equipment items simultaneously commence a transmission of messages, another equipment item can possibly detect a false message resulting from the combination of the two streams of binary signals sent by the two sending equipment items. The message can be wrong because the combination of the dominant and recessive states always produces a series of binary signals which differ from one to the other of the series of binary signals sent by the two senders. Another equipment item can then erroneously interpret the message received as being intended for it. This other equipment item can then confirm that it has indeed received the first message and that it is ready to receive the data. The sending equipment item or items then send the data, and the result thereof is a defective operation of all of the message transmission device.

The document mentions the possibility of such errors, and provides no solution that makes it possible to avoid such errors.

### SUMMARY OF THE INVENTION

A first problem put forward by the present invention is to design a local area network of bus type which is particularly well suited to driving We active elements of a home automation system, by guaranteeing the possibility of connecting a large number of active objects or elements, and by guaranteeing the possibility of interruptions in case of need without any object being able to monopolize the bus, to manage the alarm priorities.

Another problem is to design a local area network of bus type which is easily parameterizable upon installation in a particular home automation system, in particular for managing priorities.

Efforts are also made to design a local area network that is reliable, capable of transmitting the instructions and information rapidly and without error.

In the description and the claims, the term “bus” is used to denote, without distinction, a wired local area network based on twisted or coaxial conductors, or a local area network based on optical fiber, or a local area network based on wave transmission (radio waves, sound waves or light waves for example).

To achieve these aims and others, the invention proposes, according to a first aspect, a method for communication in a home automation network, allowing communication between actors of the network each having an electronic interface with communication program and associated with equipment items in a building, by means of messages transmitted over the network in the form of frames comprising a plurality of functional segments,

in which said message frame comprises:
a start-of-message segment,
an address segment,
a data length indication segment,
a data segment,
a control segment, containing a key computed as a function of the signals that make up the message,
an end-of-message binary signal,
   and in which:
before sending a message, the actor must scan for the possible presence of messages on the network and must, after having confirmed the absence of messages on the network, send a start-of-message binary signal then wait for an idle time whose duration has been assigned uniquely to it, and continue sending its message over the network only if no other message has appeared on the network during said idle time.

Because the idle time is mandatory and the idle time duration is assigned uniquely to each actor of the network, conflict in the case of the sending of several simultaneous messages over the network are managed automatically as a function of the order of priority defined by the duration of the idle time: the actors benefiting from a shorter idle time duration automatically have priority over the actors benefiting from a longer idle time duration, because they can more rapidly send a new message by thus forcing the other actors to wait for the end of the priority messages. During the parameterizing of the network, it is thus possible to assign to the priority actors a short idle time duration. The operating defects observed on the equipment items of the prior art, particularly upon a collision between the starts of messages from several simultaneous senders, are definitely avoided.

To uniquely assign an idle time duration to each actor of the network, it is in particular possible to compute the idle time durations based on the address segment of the actors of the network.

According to an advantageous embodiment, provision can be made for:
the data segment of the message to be organized as an integer number of parcels each composed of a start-of-parcel binary signal, an end-of-parcel binary signal, and 64 data binary signals,
the data length indication segment of the message consists of said integer number of parcels that make up said data segment of the message.

In this way, the length of the messages is essentially variable, and can easily be adapted to the volumes of data necessary for driving the active members of a home automation system.

It is advantageously possible to limit to 16 the number of parcels present in a message, in order to avoid priority actors being disturbed by an excessive waiting time to await the end of transmission of a current message.

To simplify the parameterizing of the local area network upon its installation, it is advantageously possible to provide for the duration of the idle time assigned to each actor to be an ascending function of the number constituting the address of said actor.

In this way, it is sufficient to appropriately choose the addresses of the different actors, the latter simultaneously defining the order of priority.

To make the data transmission in the home automation network reliable, while observing the priorities, it is advantageously possible to provide for, upon the transmission of a message over the network between a sending actor and a recipient actor:
after the end of sending of the message over the network, the sending actor to scan the messages on the network and await the reception of a reception acknowledgement message,
on the reception of the message which is intended for it over the network, the recipient actor to perform a control sequence by comparison between the data of the message and the key contained in the control segment of the message,
if the comparison between the data of the message and the key is satisfactory, the recipient actor to send over the network to the sending actor a reception OK message,
if the comparison between the data of the message and the key is unsatisfactory, the recipient actor to send over the network to the sending actor an error message,
on reception of a reception OK message, the sending actor to abstain from any other sending over the network during its waiting sequence,
on reception of an error message, the sending actor to abstain from sending over the network during its waiting sequence, then resume, if possible, the transmission of its message over the network.

As an alternative, still to make the data transmission in the home automation network reliable, while observing the priorities, it is advantageously possible to provide for, upon the transmission of a message over the network between a sending actor and a recipient actor:
after the end of sending of the message over the network, the sending actor to scan the messages on the network and a wait the reception of a reception acknowledgement message,
on the reception of the message which is intended for it over the network, the recipient actor to perform a control sequence by comparison between the data of the message and the key contained in the control segment of the message,
if the comparison between the data of the message and the key is satisfactory, the recipient actor to send over the network to the sending actor a reception OK message,
on reception of a reception OK message, the sending actor to abstain from any other sending over the network during its waiting sequence,
in the absence of reception of a reception OK message for a predetermined duration, the sending actor to once again send its message over the network.

In this alternative, if the comparison between the data of the message and the key is unsatisfactory, the recipient actor sends no message over the network. It is the sending actor which, not having received a reception OK message for a predetermined duration (corresponding for example to the return time for a reception OK message), once again sends its message over the network.

Advantageously, after a predetermined number of unsuccessful sendings of the message over the network (no reception OK message having been received by the sending actor), the sending actor can send a recipient actor malfunction message for the attention of the other sending actors of the network or for the attention of a centralized (or decentralized) control system responsible for storing and indexing any malfunctions of the recipient actors for the purposes of maintenance operations.

Also, when it does not have a message to send, each of the actors executes a current waiting sequence during which:
the actor scans for the presence of messages on the network,
in the presence of a message, the actor compares the content of the address segment of said message with its own address,
in case of difference between the content of the address segment of said message and its own address, the actor returns to the current waiting sequence,
in case of a match between the content of the address segment of said message and its own address, the actor undertakes a control sequence, by comparison between the data of the message and the key contained in the control segment of the message,
if the comparison between the data of the message and the key is unsatisfactory, the recipient actor sends over the network to the sending actor an error message, and returns to the current waiting sequence,
if the comparison between the data of the message and the key is satisfactory, the recipient actor sends over the network to the sending actor a reception OK message, then uses the data of the message.

According to another aspect, to achieve these aims and others, the invention proposes a communication device in a home automation network, allowing communication between actors of the network each having an electronic interface with communication program and associated with equipment items in a building, by means of messages transmitted over the network in the form of frames comprising a plurality of functional segments,

in which said message frame comprises:
a start-of-message segment,
an address segment,
a data length indication segment,
a data segment,
a control segment, containing a key computed as a function of the signals that make up the message,
an end-of-message binary signal,
   and in which:
the communication program of each of the actors comprises an initial waiting sequence according to which, before sending a message, the actor must scan for the possible presence of messages on the network and must, after having confirmed the absence of messages on the network, send a start-of-message binary signal then wait for an idle time whose duration has been assigned uniquely to it, and continue sending its message over the network only if no other message has appeared on the network during said idle time.

In such a device, provision can advantageously be made for:
the data segment of the message to be organized as an integer number of parcels each composed of a start-of-parcel binary signal, an end-of-parcel binary signal, and 64 data binary signals,
the data length indication segment of the message to consist of said integer number of parcels that make up said data segment of the message.
   Also, provision can be made for said integer number of parcels to be less than or equal to 16.

According to an advantageous embodiment, provision can be made for the communication program of each of the actors to comprise an idle time computation sequence, according to which the idle time is computed as a function of the number constituting the address of said actor. The computation sequence can thus be used when parameterizing a new home automation network, by appropriately choosing the addresses to define the priorities of the actors.

Preferably, the communication program of each of the actors comprises a reception wait sequence according to which, after the end of sending of a message over the network, the actor scans the messages on the network and awaits the reception of a reception acknowledgement message.

In addition, provision can advantageously be made for the communication program of each of the actors to comprise a current waiting sequence during which:
the actor scans for the presence of messages on the network,
in the presence of a message, the actor compares the content of the address segment of said message with its own address,
in case of difference between the content of the address segment of said message and its own address, the actor returns to the current waiting sequence,
in case of a match between the content of the address segment of said message and its own address, the actor uses the message.

To ensure a good message transmission reliability, provision can be made for the communication program of each of the actors to comprise a control sequence, which performs a comparison between the data of the message and the key contained in the control segment of the message, and at the end of which:
if the comparison between the data of the message and the key is unsatisfactory, the recipient actor sends over the network to the sending actor an error message, and returns to the current waiting sequence,
if the comparison between the data of the message and the key is satisfactory, the recipient actor sends over the network to the sending actor a reception OK message, then uses the data of the message.

According to another aspect, the invention proposes a home automation network provided with a communication device as defined above.

The operation of a communication device as defined above, and the progress of a communication method as defined above, are not incompatible with the continuous mode operation steps, in which a sender can indicate, in a first message following the establishment of a communication between the sender and a receiver, that the transmission of the data will then be performed continuously, until it runs out, in particular to transmit a large volume of data in a minimum time. In this case, the first message contains a data length indication segment which informs the receiver or receivers of the uninterrupted nature of the subsequent data transmission.

### BRIEF DESCRIPTION OF THE DRAWINGS

Other objects, features and advantages of the present invention will emerge from the following description of particular embodiments, given in relation to the attached figures, in which:

FIG. 1 is a schematic view of a home automation network according to an embodiment of the present invention;

FIG. 2 illustrates a message frame and the corresponding binary signals, according to an embodiment of the present invention;

FIG. 3 illustrates the frame of a parcel of data in a message according to an embodiment of the present invention;

FIG. 4 illustrates the frame of a parcel of data in a message according to a preferred embodiment of the present invention, better suited to home automation;

FIG. 5 illustrates in more detail the binary signals contained in the frame of a parcel according to FIG. 4;

FIG. 6 illustrates six examples of messages intended to control various actors of the home automation network; and

FIG. 7 is a flow diagram illustrating the essential steps in transmission of a message according to an embodiment of the present invention.

### DESCRIPTION OF PREFERRED EMBODIMENTS

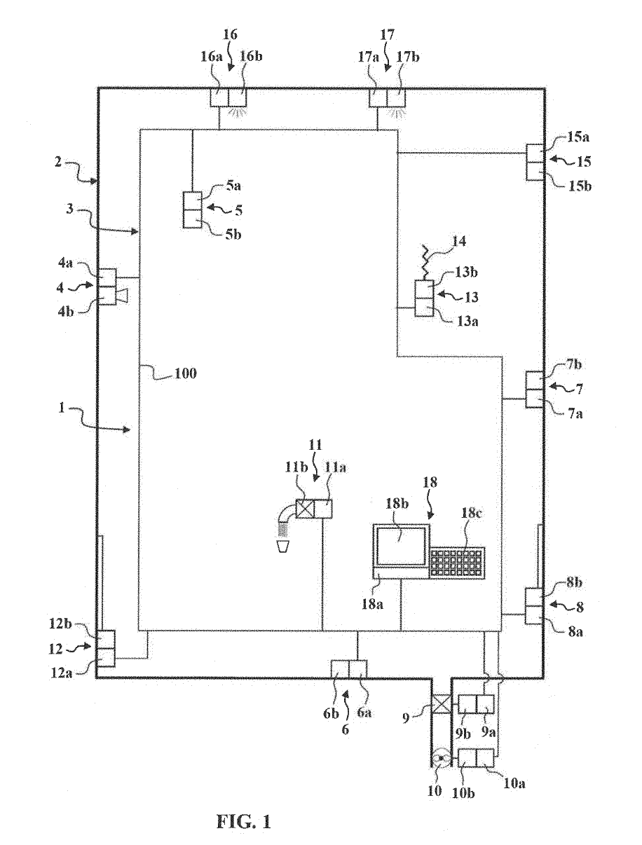

In the embodiment illustrated in FIG. 1, a home automation system is installed in a dwelling 2.

The home automation system generally comprises actors 4-18 distributed in the dwelling 2 and communicating with one another via a communication device 3 to form a home automation network 1.

In the example illustrated, the actors of the home automation network 1 comprise an alarm siren 4, a biometric sensor 5, a surveillance camera 6, a motion sensor 7, a window sensor 8, a hot air intake valve 9, a fan 10, a water intake solenoid valve 11, a garage door actuator 12, a power supply control 13 for a heating resistor 14, a controlled electrical outlet 15, controlled light points 16 and 17, and a control device 18.

Each of the actors 4-18 of the network 1 comprises an electronic interface with communication program, functionally interposed between the corresponding equipment item of the actor and a bus 100 over which the messages circulate between the actors.

Thus, the alarm siren 4 comprises an alarm electronic interface 4a interposed between the bus 100 and the functional equipment item 4b generating the alarm sound signal. Similarly: the biometric sensor 5 comprises an electronic interface of biometric sensors 5a and the functional members 5b of the sensor; the camera 6 comprises a camera interface 6a and the image-capturing members 6b of the camera; the motion sensor 7 comprises its electronic interface 7a and its functional sensor members 7b; the window sensor 8 comprises its interface 8a and its functional sensor members 8b; the valve 9 comprises its valve interface 9a and the valve actuator 9b; the fan 10 comprises its fan interface 10a and the fan motor 10b; the solenoid valve 11 comprises its solenoid valve interface 11a and the solenoid valve electromechanical actuator 11b; the door actuator 12 comprises its interface 12a and the door motor 12b; the power supply control 13 comprises its interlace 13a and an electrical switch 13b connected in series with the electrical resistor 14 at the terminals of the electrical power supply of the building; the controlled outlet 15 comprises its outlet interface 15a and a controlled switch 15b; the light points 16 and 17 comprise the respective electronic interfaces 16a and 17a and switches for selectively powering the light sources 16b and 17b.

The control device 18 comprises an electronic communication interface 18a functionally connected to the bus 100, a display device 18b and a keypad 18c.

It will be understood that the actors 4-18 illustrated in FIG. 1 are given purely in an illustrative manner, and that a home automation device according to the invention can comprise any other types of actors likely to form part of a known home automation device or of a building.

It will also be understood that most of the actors 4-18 illustrated in FIG. 1 are capable not only of receiving messages, but also of sending messages over the network, and that some of the actors illustrated may, on the contrary, be incapable of sending messages over the network 1. In the description below, it will nevertheless be assumed that all the actors are capable of sending and receiving messages.

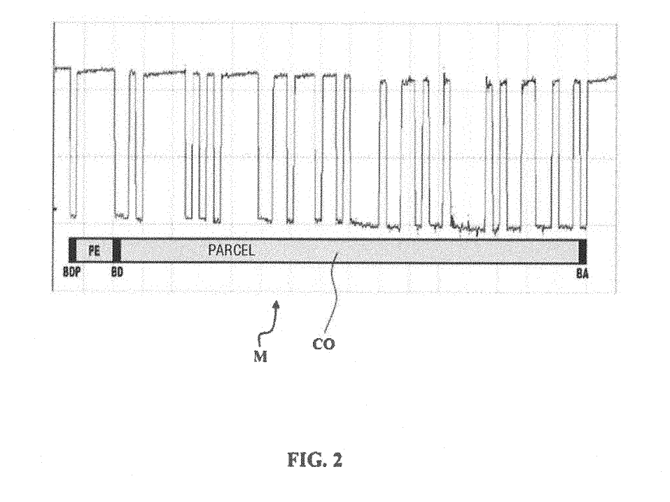

Between the actors 4 to 18, the information circulates over the bus 100 in the form of messages M made up of a series of binary signals according to a determined frame having a plurality of functional segments as illustrated in FIGS. 2 to 5.

In this frame of the message M, the following are distinguished in FIG. 2;
a start-of-message segment BDP-PE, comprising a start-of-message binary signal BDP followed by an idle time PE characterized by an absence of signal and whose length is determined by the address of the sender, this length allowing the recipients to recognize the origin of the message M,
a parcel of data CO, beginning with a start-of-parcel binary signal BD,
an end-of-message binary signal BA.

The duration of the idle time PE of the sender can for example be determined by a predefined assignment table in which a different idle time PE is uniquely correlated with each actor address of the home automation network 1.

One of the particular features of the device according to the present invention is that it makes it possible to establish priorities between the different actors of the home automation network 1. These priorities can advantageously be established in relation to the address of each actor 4-18 in the network 1. This address of each actor 4-18 can be assigned by an installer when parameterizing the device during its installation. As an alternative, it can be assigned automatically by the device, as a function of the nature of the actor concerned.

For example, in the device illustrated in FIG. 1, the following addresses can be assigned; 1001 for the alarm siren 4; 1101 for the biometric sensor 5; 1201 for the surveillance camera 6; 1301 for the motion sensor 7; 1401 for the window sensor 8; 1D01 for the hot air intake valve 9; 2101 for the fan 10; 2201 for the solenoid valve 11; 5003 for the garage door actuator 12; 4000 for the power supply control 13 of the heating resistor 14; 70F0 for the remote controlled outlet 15; 70D0 and 70F1 respectively for the light points 16 and 17; 9000 for the control device 18.

An installation program, comprising the assignment table, indicates to each actor 4-18 the idle time PE which is assigned to it, which idle time PE is stored in the electronic interface 4a-18a of the actor 4-18. This idle time PE determines the order of priority of sending of the messages M over the network 1, through an initial waiting sequence contained in the communication program of each of the actors 4-18. According to this initial waiting sequence, the actor 4-18 must, before sending a message M, scan for the possible presence of messages M on the network 1, and it must, after having confirmed the absence of messages M on the network 1, send a start-of-message binary signal BDP then wait for a duration equal to the idle time PE which has been assigned to it, and it can continue sending its message M over the network 1 only if no other message M has appeared during said idle time PE.

In practice, the assignment table of the idle time PE assigned to each actor 4-18 address can advantageously provide an idle time PE as a function of the number constituting the address of said actor 4-18, the idle time PE being preferably an ascending function of this number constituting the address of the actor 4-18.

It will then be understood that an actor 4-18 to which the lowest address has been assigned has the lowest idle time PE, and therefore has a greater priority for sending messages M over the network 1. In the above example, the alarm siren 4 will have an idle time PE whose duration is low, whereas the garage door actuator 12 will have an idle time PE whose duration is several times greater.

In the parcel CO illustrated in FIG. 2, the frame of the message M is continued by several segments which can depend on the type of parcel chosen and also on the number of parcels contained in the message M.

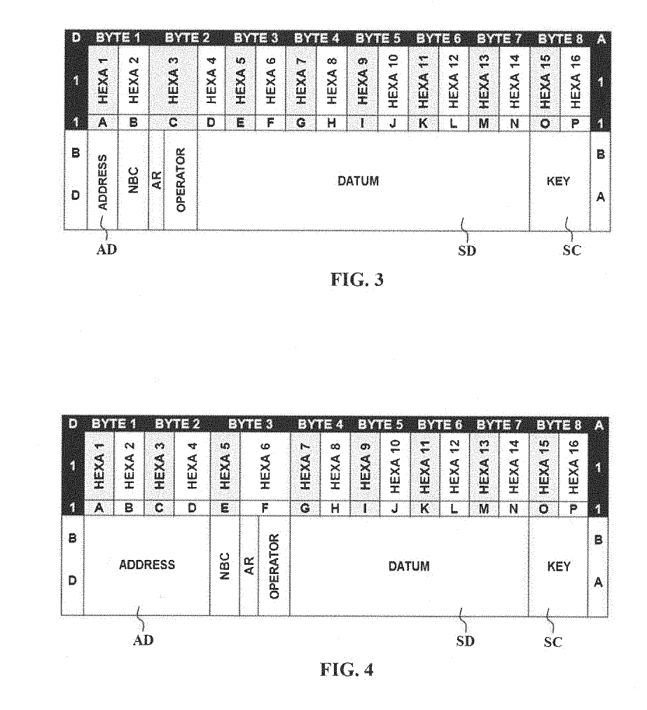

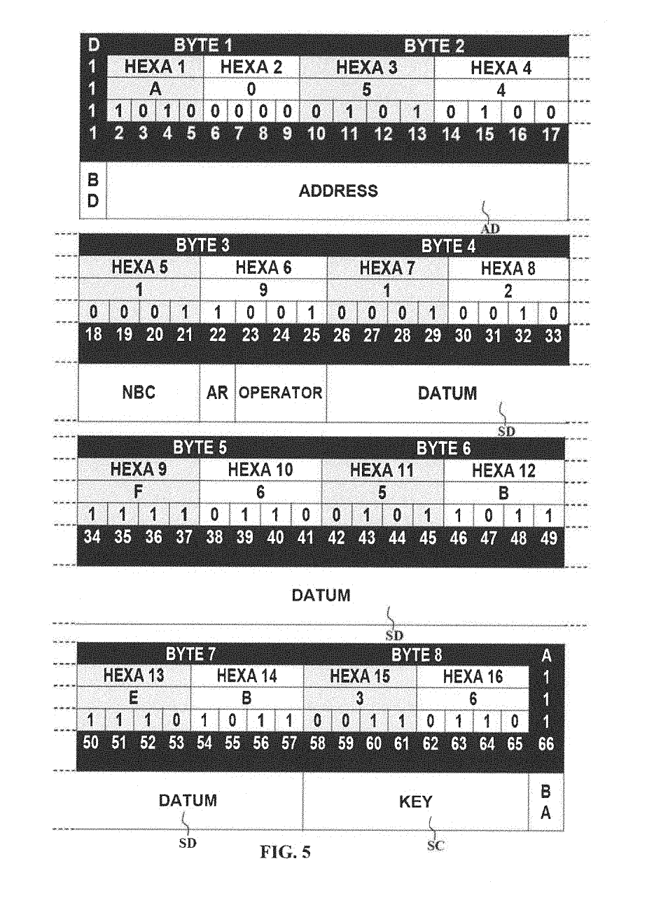

In FIGS. 3 and 4, two types of parcel have been illustrated as examples, each of which can be suitable for different applications.

In both cases, the sequence of the frame of the message M comprises:
an address segment AD,
a data length indication segment, illustrated by indication NBC, formed by four binary signals making it possible to contain a hexadecimal number from zero to 16,
a data segment SD also made up of groups each comprising four binary signals, each group thus constituting a hexadecimal number, and the groups being organized in one or more parcels, each parcel CO comprising a start-of-parcel binary signal BD, an end-of-parcel binary signal BA, and 64 data binary signals thus forming 16 hexadecimal numbers; the number of parcels that make up the data segment is equal to the hexadecimal number contained in the data length indication segment NBC,
a control segment SC, containing a key computed as a function of the signals that make up the message; the key is computed by the actor which sends the message, and a similar computation is performed by the actor which receives the message, to check the integrity thereof.

In the first example illustrated in FIG. 3, the address segment AD contains a single hexadecimal number. This example can be suitable for a network containing a small number of actors, in this case a maximum of 16 actors.

In the example illustrated in FIG. 4, the address segment AD is formed by five groups each of four binary signals, each group thus forming a hexadecimal number. This example is well suited to a network containing a larger number of actors, such as a home automation network, given that the four hexadecimal numbers make it possible to define addresses for 65 536 actors.

In practice, to make up a message M having a single parcel of data, the message M can be constructed by the assembly of the message frame M illustrated in FIG. 2 in which the frame of the parcel illustrated in FIG. 4 is incorporated.

FIG. 5 illustrates in more detail the binary signals contained in the frame of a parcel according to FIG. 4. Thus, the start-of-parcel binary signal BD, the 64 intermediate binary signals of the parcel, and the end-of-parcel binary signal BA are distinguished.

It will be noted that, in the examples illustrated in FIGS. 3 to 5, the parcel or message frame also contains an intermediate segment designated by the indications AR and OPERATOR: the indication AR designates a binary number by which the actor sending a message can indicate whether or not it wants to obtain a reception acknowledgement from its recipient. For example, the number will take the value 1 if the sender wants a reception acknowledgement, and will take the value 0 otherwise. The OPERATOR indication, comprising three binary numbers, can be used to manage addresses of groups of actors, and, generally, to tell the recipient what it has to do with the received data.

Some operating modes require the actor having sent a message to be able to ensure that the message has indeed been received. Provision is then made for the communication program of each of the actors to comprise a reception wait sequence according to which, after the end of sending of a message over the network, the actor scans the messages on the network and awaits the reception of a reception acknowledgement message which is returned to it by the recipient. On its side, the recipient which receives a message which is intended for it proceeds to check the integrity of the message that it receives, before sending a reception acknowledgement message. The integrity check is performed by comparing the data of the message and the key contained in the control segment of the message.

During operation, when there is no message to send, each of the actors executes a current waiting sequence during which it scans for the presence of messages on the network. If a message is present on the network, the actor compares the content of the address segment of the message with its own address to determine whether it is the recipient of this message. In case of difference between the content of the address segment of the message and its own address, that is to say if it is not the recipient, the actor returns to the current waiting sequence.

On the other hand, in case of a match between the content of the address segment of the message and its own address, the actor determines that it is the recipient and it undertakes a control sequence, by comparison between the data of the message and the key contained in the control segment of the message. If the comparison between the data of the message and the key is unsatisfactory, the actor sends over the network to the sending actor an error message, and returns to the current waiting sequence. If the comparison is satisfactory, the actor sends over the network to the sending actor a reception OK message, then uses the data of the message, for example by following instructions contained in the data to invoke the respective equipment item with which it is associated, if necessary to switch on a light point, to actuate a garage door, to actuate a solenoid valve.

When it wants to send a message, the actor must follow an initial waiting sequence according to which, before sending the message, it scans for the possible presence of messages on the network and, after having confirmed the absence of messages on the network, sends a start-of-message binary signal BDP then waits for an idle time PE whose duration has been assigned uniquely to it, then continuing the sending of its message over the network only if no other message has appeared during the idle time. In this way, if, in the meantime, a priority actor has sent a start-of-message binary signal, which it is allowed to do by its shorter idle time, the waiting actor abstains from continuing to send its message over the network.

If it has been able to send the message, the sending actor scans the messages on the network 1 and awaits the reception of a reception acknowledgement message if it has requested such a reception acknowledgement or awaits the reception of an error message. If it receives a reception OK message, the sending actor abstains from any other sending over the network 1 during its waiting sequence. If, on the contrary, it receives an error message which is addressed to It by the recipient, the sending actor abstains from sending over the network during its waiting sequence, then resumes, if possible, the transmission of its message over the network 1.

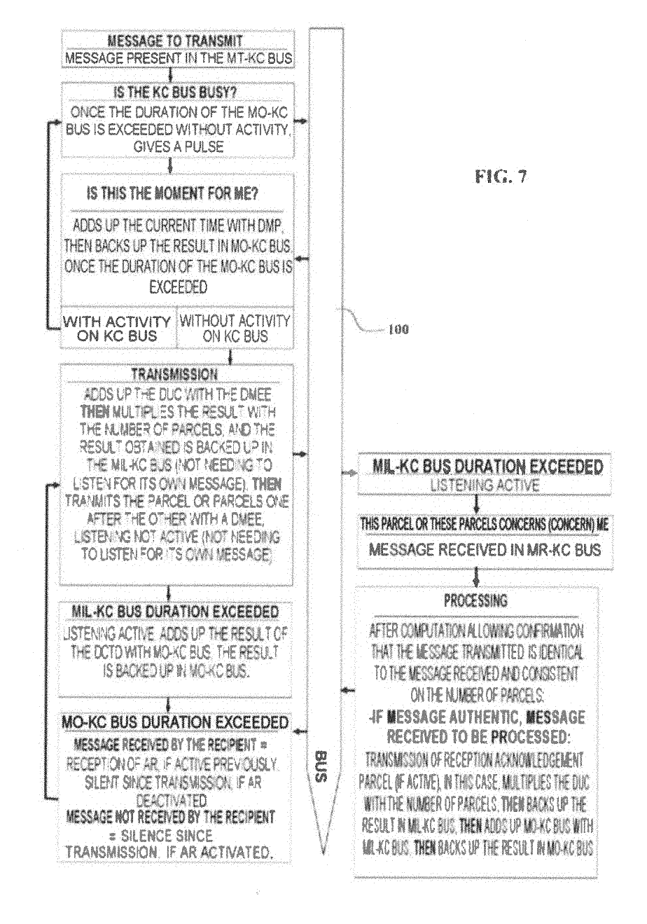

FIG. 7 is another expression, in flow diagram form, of the communication method according to an embodiment of the present invention. The message to be transmitted by an actor over the network is initially placed in a buffer memory MT of the electronic interface of the actor. The indication DUC designates the duration of a parcel, that is to say 66 times the duration of an individual binary signal. The indication DMEE is a duration chosen at least equal to the computation time needed for the recipient actor to authenticate the message received through the computation of the key, augmented by the time to transfer information over the home automation network. The indication DCTD designates the computation time for the processing by the recipient. The indication DMP is the duration of the idle time PE.

To obtain a good reliability in transmission of the messages M over the network 1, the message frame comprises a control segment SC, each sending actor computes a key as a function of the signals that make up the message M and inserts this key into the control segment SC of the message M, and each recipient actor performs a similar computation to compare the signals that make up the message M with the key contained in the control segment SC of said message M.

In practice, a good reliability can be obtained by using a control key computed by the EXCLUSIVE OR function, also called XOR or exclusive disjunction. This function is a logic operator applied to two operands which can each have the value TRUE or FALSE. According to the XOR function, the result takes the value TRUE when only one of the operands is TRUE. Applied to two binary operands A and B, taking the values 0 or 1, the result of A XOR B is equal to 0 when A and B are equal to 0, the result is equal to 1 when A or B is equal to 1, and the result is equal to 0 when A and B are both equal to 1.

According to one embodiment of the invention, the control segment SC contains two hexadecimal numbers. The first hexadecimal number contained in the control segment SC is computed by applying the XOR function to the succession of the hexadecimal numbers of odd rank contained in the message M: the XOR function is applied to the first and to the third numbers, then the XOR function is applied to the result and to the fifth number, then to the result and to the seventh number, and so on. The second hexadecimal number contained in the control segment SC is computed similarly applying the XOR function to the succession of the hexadecimal numbers of even rank contained in the message M.

During the control sequence performed by an actor receiving the message M, the recipient actor performs, on the message M, the same computations as the sending actor, by applying the XOR function to the hexadecimal numbers of odd rank then to the hexadecimal numbers of even rank, and it compares the result with the content of the control segment SC of the message M. In case of a match, the reception is considered correct. In case of a difference, the message M received is considered incorrect.

In the case of a home automation network with wired bus in particular, the transmissions of the messages are somewhat degraded when the network is relatively long, the rising and falling edges of the binary signals becoming deformed. These deformations can result in an incorrect interpretation of the electrical signals received, possibly giving rise to errors in the number or in the value of the binary signals.

To avoid these drawbacks which lead to a loss of reliability, it is advantageously possible to introduce, according to the invention, into the electronic interfaces 4a-18a of the actors 4-18 of the network 1, a signal interpretation table, defined by trial and error by the prior comparison between the durations of continuous signals sent and the durations of continuous signals received as interpreted by the microcontrollers of the electronic interfaces. For example, it has been possible to confirm that a 30 μs individual binary signal sent is interpreted, by different receiving microcontrollers, as a signal that can last from 44 to 56 μs. Similarly, it has been possible to confirm that a 60 μs double binary signal sent is interpreted, by different receiving microcontrollers, as a signal that can last from 92 to 100 μs. It is then defined, in the signal interpretation table, that a received signal of less than (92+56)/2=74 μs is a 30 μs individual binary signal, whereas a signal received having a duration greater than 74 μs will be able to be a 60 μs double signal. A similar process will be applied for signals of greater duration, by defining the intervals and the boundaries between the integer numbers of individual binary signals.

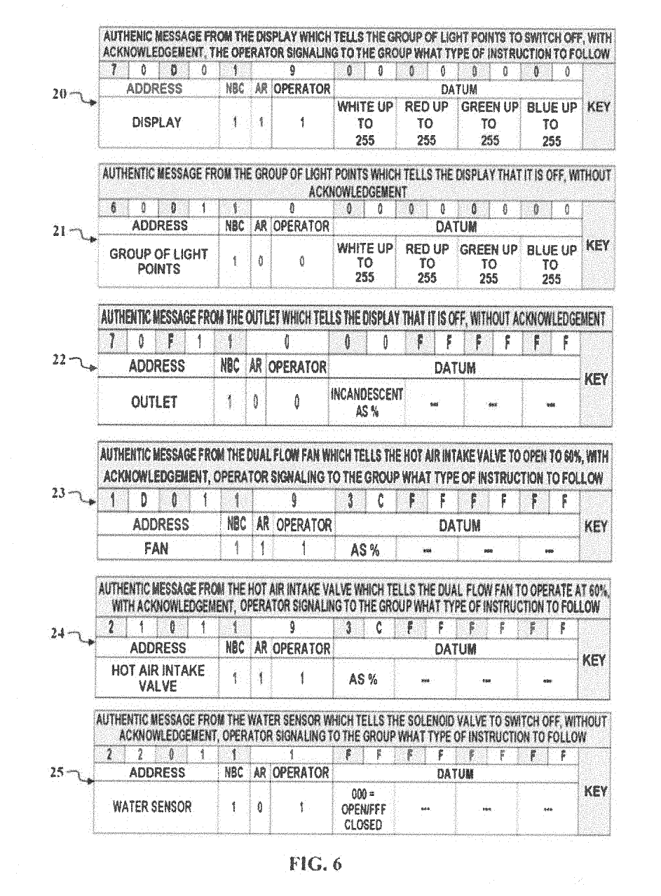

FIG. 6 illustrates examples of messages intended specifically for certain actors of the home automation network 1.

Thus, the message 20 is a control message which orders a group of light points to switch off, and which requests a reception acknowledgement. The “operator” field indicates to the group of light points what type of instruction it should follow.

The message 21 is an information message addressed by an LED lighting actor, with no request for reception acknowledgement, indicating that the lighting is off.

The message 22 is an information message addressed by a controlled current outlet actor, with no request for reception acknowledgement, indicating that the outlet is off.

The message 23 is a control message originating from a dual flow fan which orders the hot air intake valve to open to 60%, while requesting a reception acknowledgement.

The message 24 is a control message originating from the hot air intake valve, which orders the dual flow fan to advance to 60%, while requesting a reception acknowledgement, the “operator” field signaling to the group what type of instruction it should follow.

The message 25 is a control message originating from a water sensor which orders a solenoid valve to close, without requesting a reception acknowledgement.

Although described in the context of a home automation network of a building (dwelling or industrial), the present invention is also applicable to any network, including in the context of embedded systems of any transport means such as a car, a ship or an aircraft for example.

The present invention is not limited to the embodiments which have been explicitly described, but it includes diverse variants and generalizations thereof contained within the scope of the claims below.

1-14. (canceled)

15. A method for communication in a home automation network (1), allowing communication between actors (4-18) of the network each having an electronic interface (4a-18a) with communication program and associated with equipment items in a building (2), by means of messages (M) transmitted over the network (1) in the form of frames comprising a plurality of functional segments,
wherein said message frame comprises:
a start-of-message segment (BDP, PE),
an address segment (AD),
a data length indication segment (NBC),
a data segment (SD),
a control segment (SC), containing a key computed as a function of the signals that make up the message (M),
an end-of-message binary signal (BA),
and:
before sending a message (M), an actor (4-18) scans for the possible presence of messages on the network (1) then, after having confirmed the absence of messages on the network (1), sends a start-of-message binary signal (BDP) then wait for an idle time (PE) whose duration has been assigned uniquely to it, and continues sending its message (M) over the network (1) only if no other message has appeared on the network (1) during said idle time (PE).

16. The method as claimed in claim 15, wherein, for each message:
the data segment (SD) of the message (M) is organized as an integer number of parcels each composed of a start-of-parcel binary signal (BD), an end-of-parcel binary signal (BA), and 64 data binary signals,
the data length indication segment (NBC) of the message consists of said integer number of parcels that make up said data segment (SD) of the message.

17. The method as claimed in claim 16, wherein said integer number of parcels is less than or equal to 16.

18. The method as claimed in claim 15, wherein the duration of the idle time (PE) assigned to each actor (4-18) is an ascending function of the number constituting the address of said actor (4-18).

19. The method as claimed in claim 15, wherein, upon the transmission of a message (M) over the network (1) between a sending actor and a recipient actor:
after the end of sending of the message (M) over the network (1), the sending actor scans the messages on the network (1) and awaits, if necessary, the reception of a reception acknowledgement message,
on reception of the message (M) which is intended for it over the network (1), the recipient actor performs a control sequence by comparison between the data of the message and the key contained in the control segment (SC) of the message (M),
if the comparison between the data of the message and the key is satisfactory, the recipient actor sends, if necessary, over the network (1) to the sending actor a reception OK message,
if the comparison between the data of the message and the key is unsatisfactory, the recipient actor sends over the network (1) to the sending actor an error message,
on reception of a reception OK message, the sending actor abstains from any other sending over the network (1) during its waiting sequence,
on reception of an error message, the sending actor abstains from sending over the network (1) during its waiting sequence, then resumes, if possible, the transmission of its message (M) over the network (1).

20. The method as claimed in claim 15, wherein, when it does not have a message to send, each of the actors (4-18) executes a current waiting sequence during which:
the actor (4-18) scans for the presence of messages (M) on the network (1),
in the presence of a message (M), the actor (4-18) compares the content of the address segment (AD) of said message with its own address,
in case of difference between the content of the address segment (AD) of said message and its own address, the actor (4-18) returns to the current waiting sequence,
in case of a match between the content of the address segment (AD) of said message and its own address, the actor (4-18) undertakes a control sequence, by comparison between the data of the message and the key contained in the control segment (SC) of the message,
if the comparison between the data of the message and the key is unsatisfactory, the recipient actor sends over the network (1) to the sending actor an error message, and returns to the current waiting sequence,
if the comparison between the data of the message and the key is satisfactory, the recipient actor sends over the network (1) to the sending actor a reception OK message, then uses the data of the message (M).

21. A communication device in a home automation network (1), allowing communication between actors (4-18) of the network each having an electronic interface (4a-18a) with communication program and associated with equipment items in a building (2), by means of messages (M) transmitted over the network (1) in the form of frames comprising a plurality of functional segments,
wherein said message frame comprises:
a start-of-message segment (BDP, PE),
an address segment (AD),
a data length indication segment (NBC),
a data segment (SD),
a control segment (SC), containing a key computed as a function of the signals that make up the message (M),
an end-of-message binary signal (BA),
and:
the communication program of each of the actors (4-18) comprises an initial waiting sequence for an actor, before sending a message (M), to scan for the possible presence of messages on the network (1) and, after having confirmed the absence of messages on the network (1), send a start-of-message binary signal then wait for an idle time (PE) whose duration has been assigned uniquely to it, and continue sending its message (M) over the network (1) only if no other message has appeared on the network (1) during said idle time (PE).

22. The device as claimed in claim 21, wherein:
the data segment (SD) of the message (M) is organized as an integer number of parcels each composed of a start-of-parcel binary signal (BD), an end-of-parcel binary signal (BA), and 64 data binary signals,
the data length indication segment (NBC) of the message consists of said integer number of parcels that make up said data segment of the message (M).

23. The device as claimed in claim 22, wherein said integer number of parcels is less than or equal to 16.

24. The device as claimed in claim 21, wherein the communication program of each of the actors (4-18) comprises an idle time (PE) computation sequence, according to which the idle time (PE) is computed as a function of the number constituting the address of said actor (4-18).

25. The device as claimed in claim 21, wherein the communication program of each of the actors (4-18) comprises a reception wait sequence according to which, after the end of sending of a message (M) over the network, the actor (4-18) scans the messages on the network and awaits the reception of a reception acknowledgement message.

26. The device as claimed in claim 21, wherein the communication program of each of the actors (4-18) comprises a current waiting sequence during which:
the actor scans for the presence of messages on the network (1),
in the presence of a message (M), the actor (4-18) compares the content of the address segment (AD) of said message (M) with its own address,
in case of difference between the content of the address segment (AD) of said message (M) and its own address, the actor (4-18) returns to the current waiting sequence,
in case of a match between the content of the address segment (AD) of said message (M) and its own address, the actor (4-18) uses the message (M).

27. The device as claimed in claim 26, wherein the communication program of each of the actors (4-18) comprises a control sequence, which performs a comparison between the data of the message and the key contained in the control segment (SC) of the message, and at the end of which:
if the comparison between the data of the message and the key is unsatisfactory, the recipient actor sends over the network (1) to the sending actor an error message, and returns to the current waiting sequence,
if the comparison between the data of the message and the key is satisfactory, the recipient actor sends over the network (1) to the sending actor a reception OK message, then uses the data of the message (M).

28. A home automation installation comprising building equipment items associated with actors (4-18) of a home automation network (1) provided with an electronic interface (4a-18a) with communication program, wherein it comprises a communication device (3) as claimed in claim 21.
